(19) United States
(12) Patent Application Publication
(10) Pub. No.: US 2025/0285090 A1
(43) Pub. Date: Sep. 11, 2025

(54) SYSTEMS AND METHODS FOR INTERFACING AND INTEGRATING DISTRIBUTED LEDGER AND FINANCIAL SERVICES

(71) Applicant: Fin3 Technologies, Inc., New York, NY (US)

(72) Inventors: Albert SZMIGIELSKI, Surrey BC (CA); Jimmy KANG, Warren, NJ (US); Adam YARNOLD, New York, NY (US)

(21) Appl. No.: 19/217,927

(22) Filed: May 23, 2025

Related U.S. Application Data
(63) Continuation of application No. PCT/US2023/081174, filed on Nov. 27, 2023.
(60) Provisional application No. 63/385,126, filed on Nov. 28, 2022.

(51) Int. Cl. G06Q 20/06; G06Q 20/38

(52) U.S. Cl. CPC G06Q 20/065; G06Q 20/3829; G06Q 2220/00

(57) ABSTRACT

Described are systems and methods that provide an interface between financial service provider systems and blockchain ecosystems. A system may include a set of modules interfacing a financial service provider system, the set of modules including an adaptor module integratable with a core processing system of the financial service provider, and a UI module including a library of functionalities that are integratable with a UI application of the financial service provider system. The system may also include a blockchain integration module configured to adapt to the one or more blockchain ecosystems and translate one or more operations specific to a type of a blockchain ecosystem into uniform API calls. The system may further include an orchestration module in communication with the blockchain integration module via the API calls and configured to facilitate a transaction including a fiat transaction via the one or more blockchain ecosystems or a tokenized digital asset or liability transaction.

### CROSS-REFERENCE

This application is a continuation of International Patent Application No. PCT/US2023/081174, filed Nov. 27, 2023, which claims the benefit of priority to U.S. Application No. 63/385,126, filed Nov. 28, 2022, each of which are incorporated herein in their entirety.

### BACKGROUND

There is a growing interest in the usage of distributed ledger technology (e.g., blockchain), from financial transactions to smart contracts to others. Benefits of distributed ledger technology include increased transparency; accurate tracking, permanent accounting, and cost reduction. The technology can be applied in a variety of industries such as automotive, financial services, voting, healthcare, and others. In the financial services industry, benefits can include faster and cheaper settlements of financial transactions.

### SUMMARY

Traditional financial institutions such as banks have built systems that enable electronic or online transactions. With the emergence of distributed ledger technology, it can be difficult for a financial institution to modify their established system to interact with different types of distributed ledger technologies. As an example, when a corporation wants to borrow money from a bank, a typical process flow includes a corporate loan officer receiving some communication from the corporation, the officer has to make sure the covenants of the loan are met, and then authorize the loan and send the wire. Each step in the process is manually performed and requires additional time and effort and prone to mistakes, which also require additional steps of double-checking. With the use of smart contracts, the details of the loan can be encoded into the smart contract itself and transfer the money via virtual currency. Current solutions to facilitate orchestration of fiat and tokenized bank asset and liability transfers as well as other banking, financial, and similar services may involve an intermediate entity orchestrating the tokenized representation of bank asset and liabilities services and conventional banking or financial services elements. However, such intermediate entity may be fixed and limited in its ability to interact with native interfaces and systems of designated financial institutions and a designated blockchain ecosystem. A need exists for a uniform and/or dynamic interface system that is capable of interfacing with any type of native or bank core systems and/or any type of blockchain services.

In an aspect of the present disclosure, a fiat-distributed ledger integration service (interface system) is provided. The interface system can connect traditional finance based on fiat currency and newer financial technology based on distributed ledgers (e.g., blockchain). The interface system can integrate with banks' core systems and can execute transactions that are much faster, cheaper, and more secure. The interface system can connect with a variety of distributed ledger technologies to execute transactions on those blockchains. The interface system can orchestrate transactions between bank cores and distributed ledgers and to ensure transaction atomicity such that the full transaction is guaranteed to complete. Furthermore, transactions performed with the interface system can occur on both bank side and blockchain side and/or can be reverted back into their original state if needed. A plurality of modules can be populated such that the interface system is able to integrate with any bank core on the fiat currency interface and any distributed ledger ecosystem on the distributed ledger interface.

In one aspect, disclosed herein is a system for providing a blockchain interface between one or more financial service provider systems and one or more distributed ledger ecosystems. the system including a set of modules interfacing a financial service provider system, where the set of modules comprise an adaptor module integratable with a core processing system of the financial service provider, and a user interface (UI) module comprising a library of functionalities that are integratable with a UI application of the financial service provider system, wherein the library of functionalities are related to services provided by the one or more blockchain ecosystems; a blockchain integration module configured to adapt to the one or more blockchain ecosystems and translate one or more operations specific to a type of a blockchain ecosystem into uniform application programming interface (API) calls; and an orchestration module in communication with the blockchain integration module via the API calls and configured to facilitate a transaction including a fiat transaction via the one or more blockchain ecosystems or a tokenized digital asset transaction.

In some embodiments, the adaptor module is selected from a library of adaptor modules based at least in part on the core processing system of the financial service provider.

In some embodiments, the adaptor module provides a plurality of functionalities including API utilization management, failover and auto-recovery and/or securely managed credentials control.

In some embodiments, the set of modules further comprise a logging and telemetry module that is in communication with a security system of the financial service provider system.

In some embodiments, the UI module comprises a secure gateway which is deployable to a public network of the financial service provider system.

In some embodiments, at least one of the libraries of functionalities is integrated with the UI application of the financial service provider system as an integral part of a product provided by the financial service provider system.

In some embodiments, at least one of the libraries of functionalities is integrated with the UI application of the financial service provider system without being displayed to a customer on a product UI.

In some embodiments, the one or more operations comprise creation and destruction of tokens, as well as signing operations on-chain or operations specific to a product or service provided by a given blockchain ecosystem.

In some embodiments, the orchestration module comprises transactional routing and mediation logic to facilitate the transaction.

In some embodiments, the orchestration module is further configured to update the transactional routing and mediation logic upon receiving a request.

In some embodiments, the orchestration module is configured to select a different adaptor module or a different blockchain ecosystem based on the updated transactional routing and mediation logic.

In some embodiments, the request is indicative of a change of the core processing system, a change of the one or more blockchain ecosystems or a change of a service provided by the one or more blockchain ecosystems.

In some embodiments, one or more of the set of modules, blockchain integration module and the orchestration module are implemented on a cloud-based platform.

In another aspect, disclosed herein is a computer-implemented method for providing a blockchain interface between one or more financial service provider systems and one or more blockchain ecosystems, the computer-implemented method including receiving a request indicative of a change in a transaction, wherein the transaction involves a financial service provider system and a blockchain ecosystem; based at least in part on the request, determining a set of modules interfacing the financial service provider system, wherein the set of modules comprise an adaptor module selected from a plurality of adaptor modules based at least in part on a core processing system of the financial service provider; determining a blockchain integration module that adapts to the blockchain ecosystem; and deploying a model comprising the blockchain integration module, the set of modules interfacing the financial service provider system and an orchestration module to facilitate the transaction.

In some embodiments, the adaptor module provides a plurality of functionalities including API utilization management, failover and auto-recovery and/or securely managed credentials control.

In some embodiments, the set of modules further comprise a user interface (UI) module.

In some embodiments, the UI module comprises a library of functionalities that are integratable with a UI application of the financial service provider system.

In some embodiments, the library of functionalities is related to services provided by the one or more blockchain ecosystems.

In some embodiments, the UI module comprises a secure gateway which is deployable to a public network of the financial service provider system.

In some embodiments, the set of modules further comprise a logging and telemetry module that is in communication with a security system of the financial service provider system.

In some embodiments, the blockchain integration module is configured to translate one or more operations specific to a type of the blockchain ecosystem into uniform application programming interface (API) calls.

In some embodiments, the orchestration module is configured to facilitate the transaction including a fiat transaction via the blockchain ecosystem or a tokenized digital asset or liability transaction.

In some embodiments, the orchestration module comprises transactional routing and mediation logic to facilitate the transaction.

Another aspect provides a non-transitory computer readable medium comprising machine executable code that, upon execution by one or more computer processors, implements any of the methods above or elsewhere herein.

Another aspect provides a system comprising one or more computer processors and computer memory coupled thereto. The computer memory comprises machine executable code that, upon execution by the one or more computer processors, implements any of the methods above or elsewhere herein.

Additional aspects and advantages of the disclosure will become readily apparent to those skilled in this art from the following detailed description, whereby illustrative embodiments are shown and described. As will be realized, the disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF THE DRAWINGS

A better understanding of the features and advantages of the present subject matter will be obtained by reference to the following detailed description that sets forth illustrative embodiments and the accompanying drawings of which:

FIGS. 1, 2, and 3 show non-limiting examples of block diagrams of an architecture of a system, in accordance with some embodiments.

FIGS. 4, 5, and 6 show non-limiting examples of a process flow of a transaction that uses the fiat-distributed ledger integration system, in accordance with one or more embodiments.

FIG. 7 shows a non-limiting example of a computing device; in this case, a device with one or more processors, memory, storage, and a network interface, in accordance with one or more embodiments.

FIG. 8 shows a non-limiting example of a web/mobile application provision system; in this case, a system providing browser-based and/or native mobile user interfaces, in accordance with one or more embodiments.

FIG. 9 shows a non-limiting example of a cloud-based web/mobile application provision system; in this case, a system comprising an elastically load balanced, auto-scaling web server and application server resources as well synchronously replicated databases, in accordance with one or more embodiments.

### DETAILED DESCRIPTION

Described herein are systems and methods for bridging traditional banking technology and distributed ledger technology. A popular type of distributed ledger technology includes blockchains that includes a growing list of records that are securely linked together using cryptography. A virtual currency can be hosted on or built over a blockchain and designed to work as a medium of exchange through a computer network that is not reliant on any central authority, such as a government, to uphold or maintain it. Virtual currencies utilize a decentralized system through the distributed ledger for verifying that the parties to a transaction have the money they claim to have.

A type of virtual currency includes tokens where the price is designed to reference a specific asset, such as fiat currency (e.g., U.S. Dollar). Tokenized bank deposits, which is a type of virtual currency, as a payment infrastructure alternative to traditional fiat currency has high promise because tokenized bank deposit transactions are cheaper, faster, and more secure. For example, a tokenized bank deposit transaction can cost less than one cent, while a money transfer using Zelle or wires can cost dozens of times more by the bank. Furthermore, payments made by a tokenized bank deposit can settle within minutes, whereas a payment using automated clearing house (ACH) can take days. Furthermore, tokenized bank deposit transactions can leverage the distributed ledger technology of blockchains to ensure that the transactions are irreversible, making it more secure than traditional fiat-based transactions.

When a corporation wants to obtain a loan from a bank, a typical process flow includes a corporate loan officer receiving some communication from the corporation. The officer makes sure the covenants of the loan are met, and then authorize the loan and send the wire. Each step in the process is manually performed and requires additional time and effort and is prone to mistakes, which also require additional steps of double-checking. The systems and methods described herein can address the above deficiencies or shortcomings in traditional financial systems by enabling a modular interface system that can interface a variety of financial platforms and a variety of distributed ledger ecosystems. For example, the interface system herein may allow a traditional bank to use virtual currencies for real-time fiat payments. Banks can automatically create tokenized bank deposits and use them for payments. By leveraging the set of application programming interfaces (APIs) exposed by the various platforms, the disclosed technology can integrate the traditional fiat-based banks with the distributed ledger technology such that any bank can offer products and services that are based on any distributed ledger technology.

Although the disclosed technology is described with reference to banks, embodiments are not limited thereto, and a variety of other financial institutions may be used. For example, credit unions, trading houses, liquidity providers, and/or other financial institutions may implement the described technology.

### Certain Definitions

Unless otherwise defined, all technical terms used herein have the same meaning as commonly understood by one of ordinary skill in the art to which the present subject matter belongs.

As used in this specification and the appended claims, the singular forms “a,” “an,” and “the” include plural references unless the context clearly dictates otherwise. Any reference to “or” herein is intended to encompass “and/or” unless otherwise stated.

Reference throughout this specification to “some embodiments,” “further embodiments,” or “a particular embodiment,” means that a particular feature, structure, or characteristic described in connection with the embodiment is included in at least one embodiment. Thus, the appearances of the phrase “in some embodiments,” or “in further embodiments,” or “in a particular embodiment” in various places throughout this specification are not necessarily all referring to the same embodiment. Furthermore, the particular features, structures, or characteristics can be combined in any suitable manner in one or more embodiments.

As used herein, the term “real-time” generally refers to a response time of less than 10 minutes, 1 minutes, 1 second, tenth of a second, hundredth of a second, a millisecond, or less, such as by a computer processor. Real-time can also refer to a simultaneous or substantially simultaneous occurrence of a first event with respect to occurrence of a second event. Substantially as used in the above context may refer to a deviation of between ±1% to ±10% of an expected response time, execution time or execution speed.

### Architecture

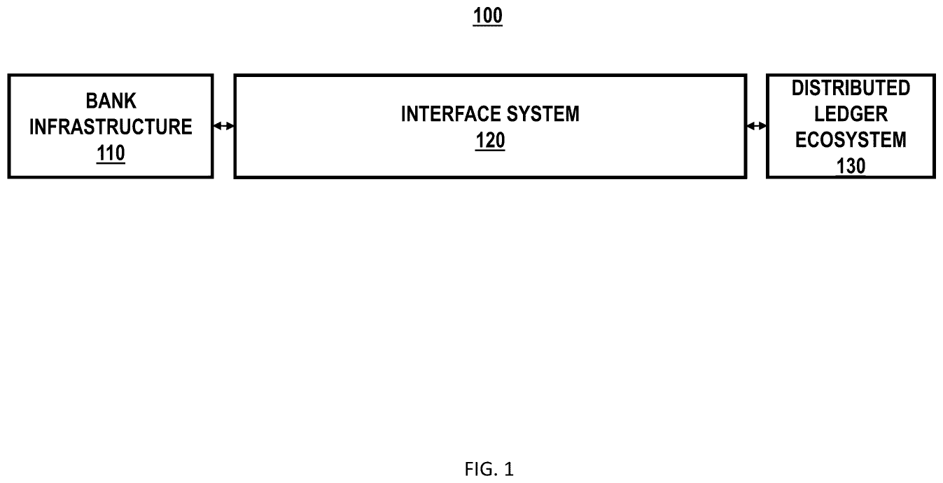

FIG. 1 shows a block diagram of an architecture of a system 100, in accordance with some embodiments. The ecosystem 100 can include bank infrastructures (e.g., one or more financial service provider systems) 110, an interface system (e.g., a fiat-distributed ledger interface system (interface system)) 120, and distributed ledger platform (e.g., one or more blockchain ecosystems) 130. The interface system 120 can orchestrate the payment transactions between fiat-based currency of the bank infrastructures 110 and distributed ledger-based currency of the distributed ledger ecosystem 130. In some embodiments, the interface system 120 can be integrated between the bank infrastructure 110 and a distributed ledger ecosystem 130. The interface system 120 can be used to interface between a traditional financial institution (e.g., bank) and the distributed ledger ecosystem 130.

The interface system 120 can perform blockchain integration functions, bank core integration functions, and payment orchestration. For example, the payment orchestration or blockchain integration functions may include minting, burning, and administration of the virtual currency. Bank core integration functions can include transferring the fiat currency to and from reserve accounts that are managed by the bank infrastructure 110. Payment orchestration can include orchestrating the payment transaction such that the customer who is initiating the transaction on the bank infrastructure 110 can successfully transfer the money to the recipient.

For example, a customer of the bank having the bank infrastructure 110 may desire to make a transaction using a tokenized digital asset or liability that is hosted on the distributed ledger 130 (e.g., virtual currency). The bank infrastructure 110 can provide a graphical user interface (GUI) portal to the customer to initiate a transaction. The customer can enter information, such as recipient (payee), amount, virtual currency, payment date, etc. The bank infrastructure 110 can provide, via a plurality of APIs, the customer-entered information as well as the customer's account information (e.g., name, routing number, account number, etc.) to the interface system 120. The interface system 120 can receive the information (e.g., customer-entered information and account information) and perform a series of operations to convert the fiat currency amount into a virtual currency amount.

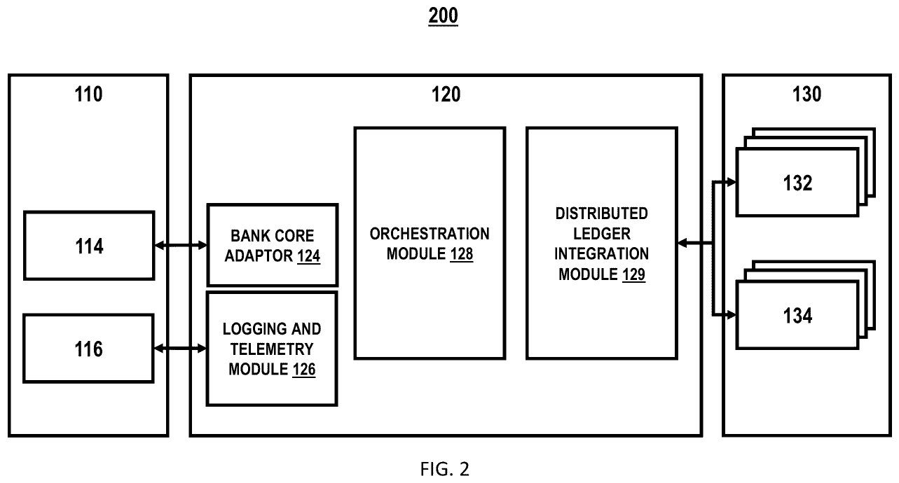

FIG. 2 shows a block diagram of an architecture of an ecosystem 200 in which an interface system 120 can be implemented or deployed. The ecosystem 200 may comprise the bank infrastructure 110, the interface system 120, and distributed ledger ecosystem 130 which are respectively similar to the bank infrastructure 110, the interface system 120, and distributed ledger ecosystem 130 described with reference to FIG. 1. The interface system 120 can include one or more modules dynamically assembled for performing several functions based at least in part on the bank infrastructure and the distributed ledger ecosystem. In some embodiments, the interface system 120 may comprise a bank core adaptor module 124, a logging and telemetry module 126, an orchestration module 128, and a distributed ledger integration module 129. Although several discrete modules are shown in FIG. 2, embodiments are not limited thereto, and one or more modules can be combined and/or one or more modules can be separated into more modules. Furthermore, although the function and description of the modules are described with respect to a specific module, this is for ease of description and embodiments are not limited thereto.

The orchestration module 128 can perform the transactional routing and mediation logic for supporting distributed ledger-backed banking products. For example, the orchestration module 128 may implement the transactional routing and/or mediation logic to provide critical guarantees that transactions that move fiat via a distributed ledger complete successfully and with integrity. The orchestration module 128 can accommodate to changes in integration business requirements and transaction flow logic through modular configuration, addressing the need for banks to adapt quickly to emerging market solutions in the evolving and expanding financial technology space.

The interface system 120 may comprise a set of one or more first modules 124 that can be deployed to interface with one or more banks with one or more different bank cores. For example, the set of one or more first modules 124 can be configured to connect to or interface with one or more banking platforms such as Jack Henry™, FIS™, Fiserv™, or Finxact™, although not limited thereto. The interface system 120 or the orchestration module 128 can include a first module 124 for each of the banking platforms that can be deployed to interface with a bank that is hosted on one of the banking platforms. For example, a bank called ABC Bank can use the Jack Henry banking platform for its online banking solution. A first module 124 corresponding the Jack Henry platform can be deployed to electronically interface with the ABC Bank. The module 124 can include a set of APIs that can be used by the ABC Bank to connect the ABC Bank's bank infrastructure 110 to the interface system 120.

The interface system 120 or the orchestration module 128 can also include a set of one or more second modules 127 that can be deployed to interface with one or more data security and key management of the virtual currency. For example, the set of one or more second modules 127 can be configured to connect to or interface with one or more data security platforms such as Fireblocks™, Fortanix™, or Amazon Web Services™ Key Management Service (AWS KMS), although not limited thereto. The interface system 120 or the orchestration module 128 can include a module 127 for each of the security platforms that can be deployed to digitally secure the minted virtual currency. For example, an initiator can initiate a payment transaction to a recipient. The initiator and the recipient can use the same or different banks that can conduct transactions via interface system 120. A module 127 (or other module) in the orchestration module 128 can be deployed that can encrypt the key for the access to the minted virtual currency that is used for conducting the transaction. The module 127 can include a set of APIs that can be used by the ABC Bank and/or the distributed ledger to connect interface system 120 to the ABC Bank's bank infrastructure 110 and/or the distributed ledger ecosystem 130.

The interface system 120 or the orchestration module 128 can also include a set of one or more third modules 129 that can be deployed for interfacing with distribute ledgers (e.g., blockchains). For example, the set of one or more third modules 129 can be configured to connect to or interface with one or more distributed ledger platforms such as Stellar™, Ethereum™, or Provenance™, although not limited thereto. The interface system 120 or the orchestration module 128 can include a module 129 for each of the distributed ledger platforms that can be deployed to mint, burn, and manage a virtual currency that is hosted on the of the platforms. For example, the initiator can initiate a payment transaction to the recipient. The initiator and the recipient can use the same or different banks that can conduct transactions via interface system 120 and use virtual currency to conduct transactions. A module 129 in the orchestration module 128 can be deployed to manage the virtual currency. The module can include a set of APIs that can be used by the ABC Bank and/or the distributed ledger platform to connect interface system 120 to the ABC Bank's bank infrastructure 110 and/or the distributed ledger ecosystem 130.

The bank infrastructure 110 can include a bank platform that can interface with the interface system 120. The bank infrastructure 110 can expose a set of APIs that can be used to send and receive information between the bank infrastructure 110 and the bank core adaptor module 124. The bank infrastructure 110 can include a bank core module 114 and a bank security module 116. The bank core module 114 can include an engine that provides banking services to the bank's customers as well as interface with the financial network outside of the bank's own ecosystem. As discussed above, examples of the bank core module 114 and/or bank infrastructure 110 can include Jack Henry, FIS, Fiserv, Finxact, etc. The bank admin module 116 can include an engine that monitors telemetry and logging services for the bank.

The bank core adaptor module 124 can be selected from an adaptor library of adaptor modules. For example, the adaptor library of adaptor modules, each capable of connecting or interfacing with a different bank core platform (e.g., Jack Henry, Fiserv, FIS, Finxact, etc.). Each of the modules in the adaptor library can include a set of APIs that can be used by the bank core platforms. Each of the adaptor modules adaptor can also include failover and auto-recovery and/or securely managed credentials control functionalities. A bank core adaptor may comprise adapter specifications (e.g., Java Interface) for external facing adapters which can be implemented for host specific services invocation.

The logging and telemetry module 126 can communicate a security system of the bank infrastructure 110. Also, the logging and telemetry module 126 can provide detailed bank-facing technical operations and information security details, giving the banks visibility and auditability the bank may need.

The distributed ledger ecosystem 130 can include an ecosystem for any distributed ledger technology (e.g., Stellar, Ethereum, Provenance, etc.). The distributed ledger technology may include private and/or hybrid blockchains and/or distributed ledger technologies. Within the distributed ledger ecosystem 130, a plurality of product APIs 134 and a plurality of native APIs 132 can be exposed for use by the interface system 120. For example, the native APIs 132 can include APIs that are used for minting, burning, and/or managing a virtual currency built in the distributed ledger ecosystem 130. For example, the Provenance blockchain includes an open-source distributed credit chain (DCC) service that can access blockchain primitives to perform low level operations such as mint, burn, and signing operations on-chain using native APIs 132. Also, the product APIs 134 can include APIs that are used for products that are built over the native distributed ledger technology. For example, a product can include a service that enables bank customers to execute peer-to-peer payment transactions over a specific payment rail. The product APIs can expose access and management of tokens, which include assets (or units of value) or liabilities that are developed on top of distributed ledgers.

The interface system 120 can interface with both the native APIs 132 and the product APIs by utilizing a distributed ledger interface module 129. The distributed ledger interface module 129 can call the native APIs 132 and the product APIs 134, based on the orchestration of the transaction performed by the orchestration module 128. The interface system 120 can mix and match various services within the distributed ledger ecosystem 130 by access the native APIs 132 and/or product APIs 134. As new requirements and offerings emerge within the distributed ledger ecosystem 130, the interface system 120 can incorporate them into the orchestration service 128, including assimilating dedicated distributed ledger-specific sentry nodes, cross-chain transactions and aggregation, key management and analytics capabilities and more. The distributed ledger interface module 129 can be selected from a distributed ledger library of different distributed ledger interface modules, each one configured to interface with a different distributed ledger ecosystem.

For example, if a bank that is not yet integrated with the interface system 120 wants to integrate with the interface system 120, an administrator at the bank can provide one or more preferred settings to the interface system 120. If the administrator enters a preference for low cost, the interface system 120 can identify the distributed technology that has the lowest distributed technology that is supported by the interface system 120 (e.g., a module exists in the library).

In some embodiments, the distributed ledger ecosystem module, the adaptor modules, the logging and telemetry module, and other modules described in this disclosure can be implemented on a cloud-based platform.

Once the initiator selects a type of transaction (e.g., a certain amount of fiat currency to be transferred to a recipient using a specific virtual currency), the orchestration module 128 can update the transactional routing and mediation logic such that the user is able to send money using the specific requirements. For example, if the initiator selects one blockchain for a first payment and a second blockchain for a second payment, the orchestration module 128 can select a different blockchain ecosystem for payment. Similarly, if the initiator selects a first product for a first payment and a second product for a second payment, the orchestration module 128 can select a different distributed ledger interface module.

The interface system 120 can be configured to adapt to any type of banking platform, bank core, blockchain products and/or blockchain services, by dynamically building a combination of modules (e.g., bank core adaptor 124, logging and telemetry module 126, and distributed ledger integration module 129) to facilitate a business requirement or a transaction flow. For example, based on a particular transaction request or change of transaction request received from a financial service provider system, the interface system 120 may determine a set of modules suitable for interfacing with the financial service provider system, whereby the set of modules may comprise an adaptor module selected from a plurality of adaptor modules based at least in part on a core processing system of the financial service provider. The interface system may also determine a blockchain integration module that adapts to the blockchain ecosystem. The interface system can deploy a model comprising the blockchain integration module, the set of modules interfacing with the financial service provider system, and an orchestration module to facilitate the transaction. In some embodiments, a model can be created for each combination of a module selected from the set of the one or more first modules 124, a module selected from the set of the one or more second modules 127, and a module selected from the set of one or more third modules 129.

The models can be compiled into a model library that can be easily and seamlessly chosen from when the user inputs their preferences into the GUI portal 112. For example, when an initiator inputs that she would like to send $100 to a first recipient at GHI Bank, the orchestration module 128 can determine a model to use based on the user settings. For example, the orchestration module 128 can determine the appropriate modules to be used for the transaction, based on the initiator's input in the GUI portal 112. Then, the transactional routing and mediation logic can be updated according to the model.

Depending on a user's preference, a module from each of the first to third sets of modules can be deployed so that the user can access or conduct transactions utilizing the blockchain services (e.g., send and receive money using a virtual currency). For example, a user can prefer to use a bank that is hosted on the Jack Henry platform, uses AWS KMS for its key management. and Stellar for its distributed ledger platform. The interface system 120 can receive the user's preference and connect and/or integrate the modules together such that the user is able to send and receive payments using these platforms. The interface system 120 can integrate the modules from the first, second, and third sets of modules by utilizing the APIs that are exposed from each of the platforms.

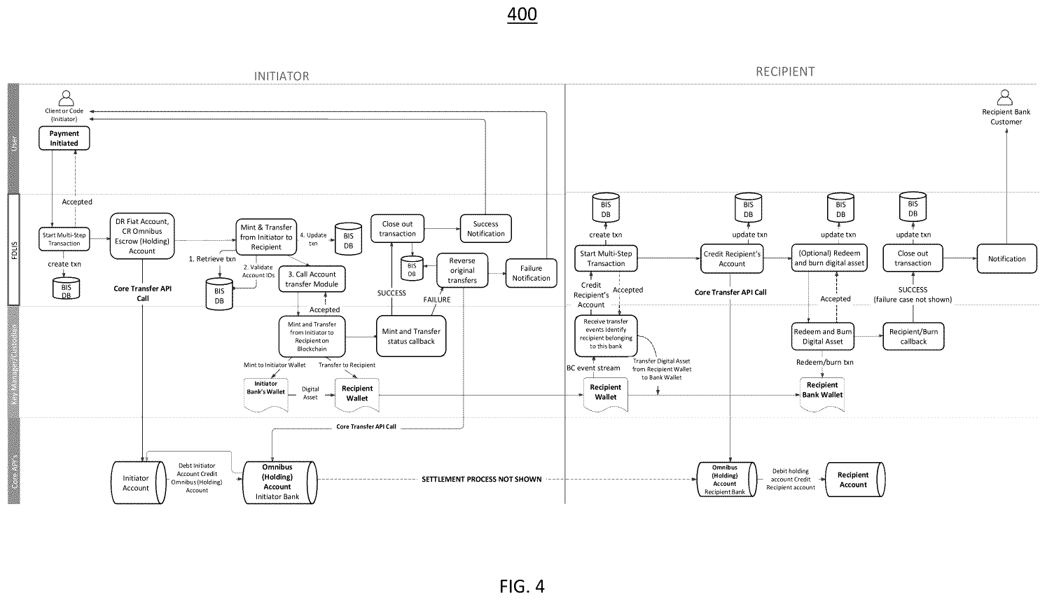

As an example, an initiator desires to transfer funds to the recipient in a peer-to-peer (P2P) transfer. The initiator can use DEF Bank that uses Jack Henry, AWS KMS, and Stellar. The recipient can use GHI Bank that uses Fiserv, Fortanix, and Stellar. The initiator can input into a GUI portal hosted by the DEF Bank that the initiator wishes to send money from the initiator's checking account to the recipient's checking account at the GHI Bank. The initiator can input a fiat currency amount into the transfer request. The DEF Bank can make an API call (e.g., “send money”) to the interface system 120 that can initiate the orchestration of the transferring the funds. The interface system 120 can then make an API call back to the DEF Bank (e.g., “retrieve private key”) to access a digital wallet of the initiator's virtual currency account. The interface system 120 can then send an API call (e.g., “mint coin”) to the Stellar ecosystem to mint a new coin (e.g., virtual currency) corresponding to the dollar amount that the initiator wants to transfer to the recipient. The interface system 120 can then send another API call (e.g., “send coin”) to the AWS KMS to transfer the minted coin to the recipient's digital wallet. The interface system 120 can send another API call (e.g., “retrieve private key”) to the GHI Bank to retrieve the recipient's private key for accessing the coin in the recipient's digital wallet. The interface system 120 can send another API call (e.g., “retrieve coin”) to the AWS KMS platform to retrieve the coin from the recipient's digital wallet. Then the interface system 120 can send an API call (e.g., “deposit money”) to the GHI Bank to deposit an amount in fiat currency corresponding to the amount that the initiator requested into a bank account at the GHI Bank. Additional details on the transfer process are described with reference to FIGS. 4-6.

In some embodiments, a variety of other types of transfers may be contemplated. For example, an initiator may desire to transfer funds to a recipient in a business-to-business (B2B) transfer. In some embodiments, a payment may be initiated as a result of a smart contract being executed. For example, once conditions or terms of the smart contract are satisfied, payment may be initiated from the initiator (peer/person or business) to a recipient (peer/person or business). As another example, payment may be initiated as part of an automatic mortgage, or interest, or bond payments. A variety of other examples may be contemplated while remaining within the scope of the disclosed technology.

In some embodiments, the ecosystem 200 may be self-configured or automatically set based on a preference of the user based on a self-configuration algorithm. The self-configuration algorithm may automatically select a distributed ledger technology that is optimized to meet or satisfy the preference of the user. For example, if an initiator wants to send money to the recipient in the fastest means possible, the self-configuration algorithm may select/add, remove, and/or configure modules such that the bank for the initiator is able to send the money to the bank of the recipient in the fastest way possible. This configuration may include, for example, setting a currency that has the fastest transaction speeds. In some embodiments, the user may set a preference for sending the money with the lowest cost. Here, the self-configuration algorithm may automatically select/add, remove, and/or configure the modules such that the bank for the initiator is able to transfer the money to the bank of the recipient at the cheapest cost. In some embodiments, the user may set a preference for both cost and speed. In this configuration, the self-configuration algorithm may automatically select/add, remove, and/or configure the modules such that the bank for the initiator is able to transfer the money to the bank of the recipient in a method that balances both cost and speed, e.g., by choosing a currency that is around the 50^{th} percentile in cost and 50^{th} percentile in speed).

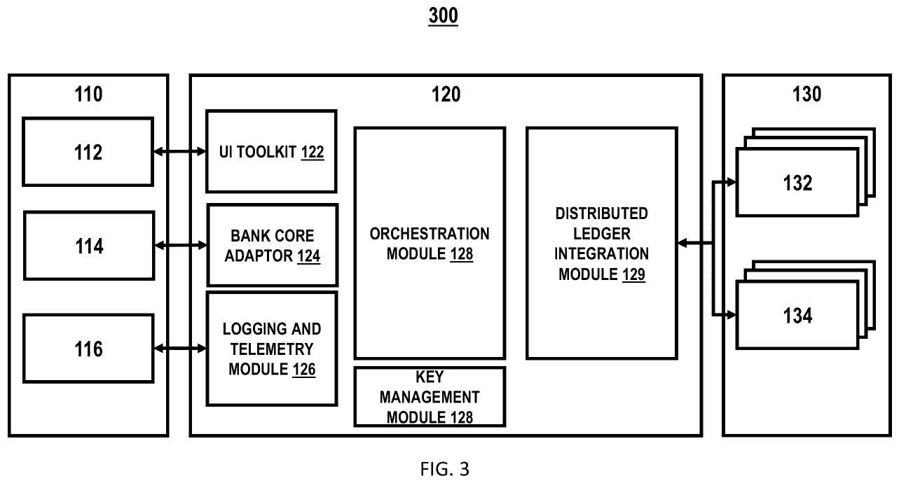

FIG. 3 shows a block diagram of an architecture of an ecosystem 200, in accordance with some embodiments. Like the ecosystem 200, the ecosystem 300 can include the bank infrastructure 110, the interface system 120, and the distributed ledger ecosystem 130 as describe above. The bank infrastructure 110 can also include bank portal (or GUI portal) 112, and the interface system 120 can include a user interface (UI) toolkit 122. The GUI portal 112 can include a GUI portal where the user can enter information related to the money transfer such as recipient name, and identification (e.g., email address), how much fiat currency and/or virtual currency to transfer, and/or date of the transfer. The UI toolkit 122 can include a security gateway that can be deployed in the bank's hardened public-facing network or demilitarized zone (DMZ). The UI toolkit 122 can also include a utility library (e.g., in JavaScript) that banks can leverage in their customer-facing applications (e.g., GUI portal 112) to weave in distributed ledger-backed product functionality. Accordingly, the banks can create user experiences in their customer and administrative portals and mobile applications that seamlessly merge traditional bank products with distributed ledger-based products and services.

The UI toolkit 122 can also offer banks flexibility into the visibility of the distributed ledger or blockchain to the end user (e.g., bank's customer). In some embodiments, the bank can want to mask the fact that distributed ledger technology is hosting a bank product by masking the visibility of the distributed ledger technology entirely. The UI toolkit 122 can also incorporate personal signing wallets into the user's GUI portal 112 and make the distributed ledger technology exposure integral to the customer.

The UI toolkit 122 can provide a functionality library that the administrator or developer can integrate into GUI portal 112 of the bank infrastructure 110. For example, the functionalities library can provide the user (e.g., initiator) all the options and/or functions for choosing a distributed ledger-based product, type of transaction, amount, etc. For example, if the initiator selects to use a specific virtual currency (e.g., Stellar), the interface system 120 can orchestrate the transaction such that the native APIs and product APIs of the specific virtual currency are used.

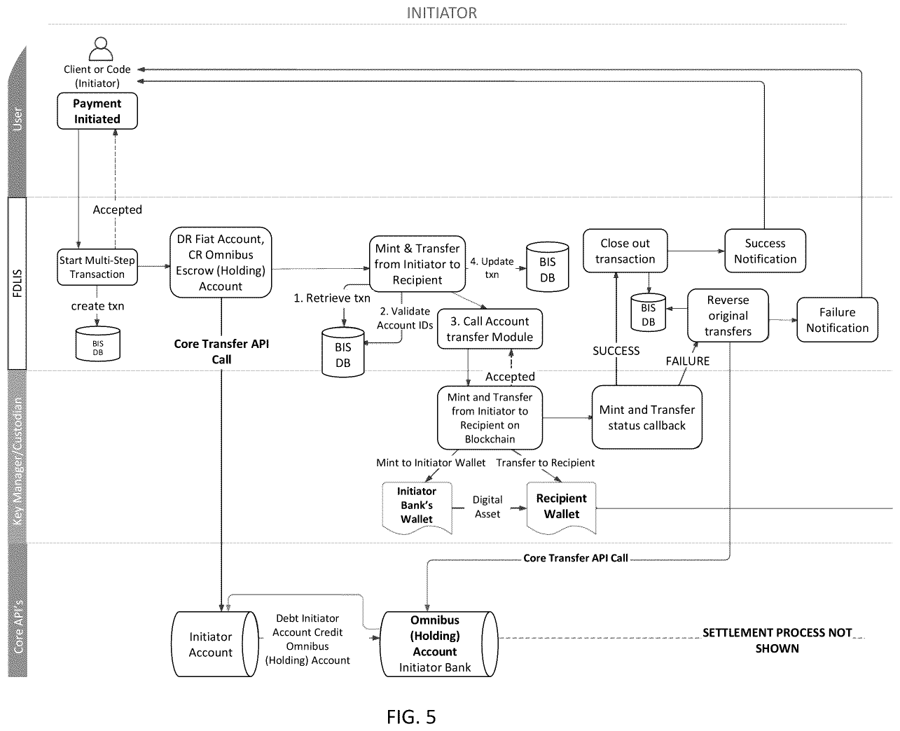

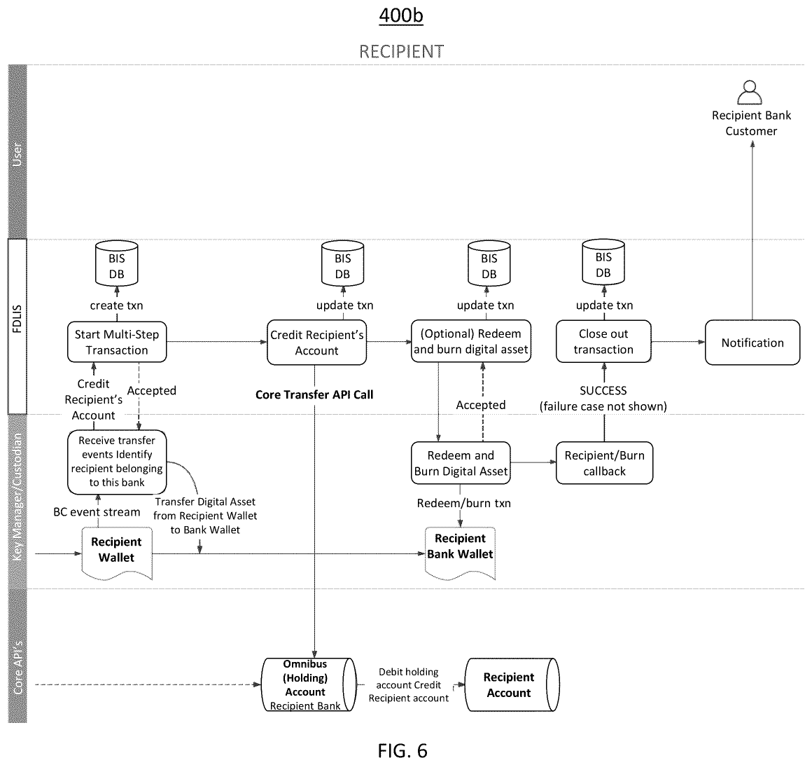

FIG. 4 shows an example process flow 400 of a transaction that uses the interface system 120, in accordance with one or more embodiments. FIG. 5 shows a flow 400a of the steps or actions on the initiator side of the process flow 400, and FIG. 6 shows a flow 400b of the steps or actions on the recipient side of the process flow 400. The steps described with reference to the process flow 400 are separated into four groups (e.g., four rows in FIGS. 4-6) for ease of explanation, but embodiments are not limited thereto, and any of the steps or actions can be performed by one or more different entities. Furthermore, any of the steps can include one or more steps that can further include additional steps, etc. Accordingly, embodiments of the payment transactions are not limited to the description in FIGS. 4-6.

The User of FIGS. 4-6 can include the initiator and/or the recipient, as shown in FIGS. 5 and 6. The interface system of FIGS. 4-6 can include the interface system 120 of FIGS. 1-3. The Key Manager/Custodian of FIGS. 4-6 can include the security platform as discussed above. And the core APIs can include the bank core APIs that can be used and/or called by the interface system.

Referring to FIGS. 4 and 5, the initiator can initiate a payment transaction using the initiator's bank's GUI portal. The initiator can initiate a payment transaction to transfer money to the recipient. Once the payment is initiated, a series of steps can be performed to orchestrate the transaction. The interface system 120 can generate an entry in a interface system database and provided a unique transaction code.

The interface system can send API calls to the bank core to withdraw from the initiator's fiat account and credit an escrow account (e.g., omnibus escrow account, holding account) connected with the initiator's fiat account, in accordance with the amount that the initiator entered in the GUI portal. The interface system can send one or more transfer API calls to withdraw funds from the initiator's fiat account at the bank (e.g., “withdraw [amount] from [initiator's fiat account]”). The interface system can also send one or more transfer API calls to deposit the funds into the initiator's escrow account.

Then, the interface system can initiate minting and transferring of virtual currencies from the initiator to the recipient. The interface system can retrieve transaction details by loading data from the interface system database using the unique transaction code. Then, the interface system can validate the transaction by using one or more ways, such as keys, account identification numbers (e.g., initiator's fiat account number), or any other method. Once the transaction has been validated, the interface system can initiate the mint and transfer process.

The interface system can mint the virtual currency by sending API calls (e.g., native APIs 132, product APIs 134) to the distributed ledger ecosystem (e.g., distributed ledger ecosystem 130). The distributed ledger system can then mint virtual currency and deposit the minted virtual currency into the initiator's digital wallet. Then the interface system can transfer the virtual currency from the initiator's digital wallet to the recipient's digital wallet. The initiator's and recipient's digital wallets can be hosted by the same financial institution or different security platform. When the interface system successfully mints and transfers the virtual currency. interface system can send API calls to the bank core to debit the funds from the initiator's escrow account and credit the same amount into the recipient's escrow account, at the same or different bank.

Once the mint and transfer of the virtual currency are complete, the interface system can provide a status of the mint and transfer of the virtual currency. If the mint and transfer were a success, the transaction is closed out, and the transaction is recorded in the database. Then a success notification is provided to the initiator.

If the mint or the transfer of the virtual currency fails, the interface system can reverse the transfer. The interface system can send API calls to the distributed ledger ecosystem to debit the funds from the escrow account and credit the funds back to the initiator's fiat account. The interface system can record the transaction as a failure in the database. Then the interface system can generate a failure notification for the initiator.

Referring to FIGS. 4 and 6, on the recipient side, when the transaction is successful, the interface system can credit the recipient's digital wallet with the virtual currency. The interface system can then identify the recipient that owns the digital wallet for the recipient. The interface system can send API calls to the bank core of the recipient's bank (same or different bank as the initiator) to debit the funds from the escrow account and credit the funds in the recipient's fiat account. Once the transaction is successfully completed, the interface system can notify the recipient.

Depending on the recipient and/or the bank's settings, the virtual currency can be redeemed and/or burned. When the virtual currency is redeemed and/or burned, the virtual currency (or token) is revoked which decreases the supply of available virtual currency for transactions. When the virtual currency is redeemed and/or burned, the interface system can send API calls to the data security platform to redeem and/or burn the virtual currency in the recipient's digital wallet. When the redemption and/or burning is complete, the transaction is successfully completed, and the interface system notifies the recipient.

### Computing System

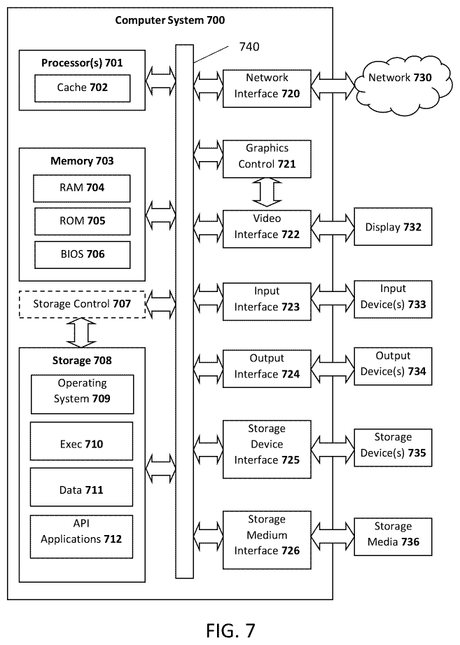

Referring to FIG. 7, a block diagram is shown depicting an exemplary machine that includes a computer system 700 (e.g., a processing or computing system) within which a set of instructions can execute for causing a device to perform or execute any one or more of the aspects and/or methodologies for static code scheduling of the present disclosure. The computer system 700 can include the components in FIG. 7 are examples only and do not limit the scope of use or functionality of any hardware, software, embedded logic component, or a combination of two or more such components implementing some embodiments.

Computer system 700 can include one or more processors 701, a memory 703, and a storage 708 that communicate with each other, and with other components, via a bus 740. The bus 740 can also link a display 732, one or more input devices 733 (which can, for example, include a keypad, a keyboard, a mouse, a stylus, etc.), one or more output devices 734, one or more storage devices 735, and various tangible storage media 736. All these elements can interface directly or via one or more interfaces or adaptors to the bus 740. For instance, the various tangible storage media 736 can interface with the bus 740 via storage medium interface 726. Computer system 700 can have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Computer system 700 includes one or more processor(s) 701 (e.g., central processing units (CPUs), general purpose graphics processing units (GPGPUs), or quantum processing units (QPUs)) that carry out functions. Processor(s) 701 optionally contains a cache memory unit 702 for temporary local storage of instructions, data, or computer addresses. Processor(s) 701 are configured to assist in execution of computer readable instructions. Computer system 700 can provide functionality for the components depicted in FIG. 7 because of the processor(s) 701 executing non-transitory, processor-executable instructions embodied in one or more tangible computer-readable storage media, such as memory 703, storage 708, storage devices 735, and/or storage medium 736. The computer-readable media can store software that implements some embodiments, and processor(s) 701 can execute the software. Memory 703 can read the software from one or more other computer-readable media (such as mass storage device(s) 735, 736) or from one or more other sources through a suitable interface, such as network interface 720. The software can cause processor(s) 701 to carry out one or more processes or one or more steps of one or more processes described or illustrated herein. Carrying out such processes or steps can include defining data structures stored in memory 703 and modifying the data structures as directed by the software.

The memory 703 can include various components (e.g., machine readable media) including, but not limited to, a random-access memory component (e.g., RAM 704) (e.g., static RAM (SRAM), dynamic RAM (DRAM), ferroelectric random-access memory (FRAM), phase-change random access memory (PRAM), etc.), a read-only memory component (e.g., ROM 705). and any combinations thereof. ROM 705 can act to communicate data and instructions unidirectionally to processor(s) 701, and RAM 704 can act to communicate data and instructions bidirectionally with processor(s) 701. ROM 705 and RAM 704 can include any suitable tangible computer-readable media described below. In one example, a basic input/output system 706 (BIOS), including basic routines that help to transfer information between elements within computer system 700, such as during start-up, can be stored in the memory 703.

Fixed storage 708 is connected bidirectionally to processor(s) 701, optionally through storage control unit 707. Fixed storage 708 provides additional data storage capacity and can also include any suitable tangible computer-readable media described herein. Storage 708 can be used to store operating system 709, executable(s) 170, data 711, applications 712 (application programs), and the like. Storage 708 can also include an optical disk drive, a solid-state memory device (e.g., flash-based systems), or a combination of any of the above. Information in storage 708 can, in appropriate cases, be incorporated as virtual memory in memory 703.

In one example, storage device(s) 735 can be removably interfaced with computer system 700 (e.g., via an external port connector (not shown)) via a storage device interface 725. Some storage device(s) 735 and an associated machine-readable medium can provide non-volatile and/or volatile storage of machine-readable instructions, data structures, program modules, and/or other data for the computer system 700. In one example, software can reside, completely or partially, within a machine-readable medium on storage device(s) 735. In another example, software can reside, completely or partially, within processor(s) 701.

Bus 740 connects a wide variety of subsystems. Herein, reference to a bus can encompass one or more digital signal lines serving a common function, where appropriate. Bus 740 can be any of several types of bus structures including, but not limited to, a memory bus, a memory controller, a peripheral bus, a local bus, and any combinations thereof, using any of a variety of bus architectures. As an example, and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus. HyperTransport (HTX) bus, serial advanced technology attachment (SATA) bus, and any combinations thereof.

Computer system 700 can also include an input device 733. In one example, a user of computer system 700 can enter commands and/or other information into computer system 700 via input device(s) 733. Examples of an input device(s) 733 include, but are not limited to, an alpha-numeric input device (e.g., a keyboard), a pointing device (e.g., a mouse or touchpad), a touchpad, a touch screen, a multi-touch screen, a joystick, a stylus, a gamepad, an audio input device (e.g., a microphone, a voice response system, etc.), an optical scanner, a video or still image capture device (e.g., a camera), and any combinations thereof. In some embodiments, the input device is a Kinect, Leap Motion, or the like. Input device(s) 733 can be interfaced to bus 740 via any of a variety of input interfaces 723 (e.g., input interface 723) including, but not limited to, serial, parallel, game port, USB, FIREWIRE, THUNDERBOLT, or any combination of the above.

In some embodiments, when computer system 700 is connected to network 730. computer system 700 can communicate with other devices, specifically mobile devices and enterprise systems, distributed computing systems, cloud storage systems, cloud computing systems, and the like, connected to network 730. Communications to and from computer system 700 can be sent through network interface 720. For example, network interface 720 can receive incoming communications (such as requests or responses from other devices) in the form of one or more packets (such as Internet Protocol (IP) packets) from network 730, and computer system 700 can store the incoming communications in memory 703 for processing. Computer system 700 can similarly store outgoing communications (such as requests or responses to other devices) in the form of one or more packets in memory 703 and communicated to network 730 from network interface 720. Processor(s) 701 can access these communication packets stored in memory 703 for processing.

Examples of the network interface 720 include, but are not limited to, a network interface card, a modem, and any combination thereof. Examples of a network 730 or network segment 730 include, but are not limited to, a distributed computing system, a cloud computing system, a wide area network (WAN) (e.g., the Internet, an enterprise network), a local area network (LAN) (e.g., a network associated with an office, a building, a campus or other relatively small geographic space), a telephone network, a direct connection between two computing devices, a peer-to-peer network, and any combinations thereof. A network, such as network 730, can employ a wired and/or a wireless mode of communication. In general, any network topology can be used.

Information and data can be displayed through a display 732. Examples of a display 732 include, but are not limited to, a cathode ray tube (CRT), a liquid crystal display (LCD), a thin film transistor liquid crystal display (TFT-LCD), an organic liquid crystal display (OLED) such as a passive-matrix OLED (PMOLED) or active-matrix OLED (AMOLED) display, a plasma display, and any combinations thereof. The display 732 can interface to the processor(s) 701, memory 703, and fixed storage 708, as well as other devices, such as input device(s) 733, via the bus 740. The display 732 is linked to the bus 740 via a video interface 722, and transport of data between the display 732 and the bus 740 can be controlled via the graphics control 721. In some embodiments, the display is a video projector. In some embodiments, the display is a head-mounted display (HMD) such as a VR headset. In further embodiments, suitable VR headsets include, by way of non-limiting examples, HTC Vive, Oculus Rift, Samsung Gear VR, Microsoft HoloLens, Razer OSVR, FOVE VR, Zeiss VR One, Avegant Glyph, Freefly VR headset, and the like. In still further embodiments, the display is a combination of devices such as those disclosed herein.

In addition to a display 732, computer system 700 can include one or more other peripheral output devices 734 including, but not limited to, an audio speaker, a printer, a storage device, and any combinations thereof. Such peripheral output devices can be connected to the bus 740 via an output interface 724. Examples of an output interface 724 include, but are not limited to, a serial port, a parallel connection, a USB port, a FIREWIRE port, a THUNDERBOLT port, and any combinations thereof.

In addition, or as an alternative, computer system 700 can provide functionality because of logic hardwired or otherwise embodied in a circuit, which can operate in place of or together with software to execute one or more processes or one or more steps of one or more processes described or illustrated herein. Reference to software in this disclosure can encompass logic, and reference to logic can encompass software. Moreover, reference to a computer-readable medium can encompass a circuit (such as an IC) storing software for execution, a circuit embodying logic for execution, or both, where appropriate. The present disclosure encompasses any suitable combination of hardware, software, or both.

Those of skill in the art will appreciate that the various illustrative logical blocks, modules, circuits, and algorithm steps described in connection with the embodiments disclosed herein can be implemented as electronic hardware, computer software, or combinations of both. To clearly illustrate this interchangeability of hardware and software, various illustrative components, blocks, modules, circuits, and steps have been described above generally in terms of their functionality.

The various illustrative logical blocks, modules, and circuits described in connection with the embodiments disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein can be embodied directly in hardware, in a software module executed by one or more processor(s), or in a combination of the two. A software module can reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

In accordance with the description herein, suitable computing devices include, by way of non-limiting examples, server computers, desktop computers, laptop computers, notebook computers, sub-notebook computers, netbook computers, netpad computers, set-top computers, media streaming devices, handheld computers. Internet appliances, mobile smartphones, tablet computers, personal digital assistants, video game consoles, and vehicles. Those of skill in the art will also recognize that select televisions, video players, and digital music players with optional computer network connectivity are suitable for use in the system described herein. Suitable tablet computers, in various embodiments, include those with booklet, slate, and convertible configurations, known to those of skill in the art.

In some embodiments, the computing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle Solaris® Windows Server®, and Novell® NetWare®. Those of skill in the art will recognize that suitable personal computer operating systems include, by way of non-limiting examples, Microsoft® Windows®, Apple Mac OS X®, UNIX®, and UNIX-like operating systems such as GNU/Linux®. In some embodiments, the operating system is provided by cloud computing. Those of skill in the art will also recognize that suitable mobile smartphone operating systems include, by way of non-limiting examples. Nokia® Symbian® OS, Apple® iOS®, Research In Motion® BlackBerry OS®, Google Android®, Microsoft® Windows Phone® OS, Microsoft® Windows Mobile® OS, Linux®, and Palm® WebOS®. Those of skill in the art will also recognize that suitable media streaming device operating systems include, by way of non-limiting examples, Apple TV®, Roku®, Boxee®, Google TV®, Google Chromecast®, Amazon Fire®, and Samsung® HomeSync®. Those of skill in the art will also recognize that suitable video game console operating systems include, by way of non-limiting examples. Sony® PS3®, Sony PS4®, Microsoft® Xbox 360®, Microsoft Xbox One, Nintendo® Wii®. Nintendo® Wii U®, and Ouya®.

### Non-Transitory Computer Readable Storage Medium

In some embodiments, the platforms, systems, media, and methods disclosed herein include one or more non-transitory computer readable storage media encoded with a program including instructions executable by the operating system of an optionally networked computing device. In further embodiments, a computer readable storage medium is a tangible component of a computing device. In still further embodiments, a computer readable storage medium is optionally removable from a computing device. In some embodiments, a computer readable storage medium includes, by way of non-limiting examples, CD-ROMs, DVDs, flash memory devices, solid state memory, magnetic disk drives, magnetic tape drives, optical disk drives, distributed computing systems including cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable by one or more processor(s) of the computing device's CPU written to perform a specified task. Computer readable instructions can be implemented as program modules, such as functions, objects. Application Programming Interfaces (APIs)., computing data structures, and the like, that perform tasks or implement particular abstract data types. In light of the disclosure provided herein, those of skill in the art will recognize that a computer program can be written in various versions of various languages.

The functionality of the computer readable instructions can be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as React Javascript. In some embodiments, a web application utilizes one or more database systems including, by way of non-limiting examples, relational, non-relational, object oriented, associative, XML, and document oriented database systems. In further embodiments, suitable relational database systems include, by way of non-limiting examples, Microsoft SQL Server, mySQL™, and Oracle®. Those of skill in the art will also recognize that a web application, in various embodiments, is written in one or more versions of one or more languages. A web application can be written in one or more markup languages, presentation definition languages, client-side scripting languages, server-side coding languages, database query languages, or combinations thereof. In some embodiments, a web application is written to some extent in a markup language such as Hypertext Markup Language (HTML). Extensible Hypertext Markup Language (XHTML), or extensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® ActionScript, JavaScript, or Silverlight®. In some embodiments, a web application is written to some extent in a server-side coding language such as Active Server Pages (ASP). ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft Silverlight®, Java™, and Unity®.

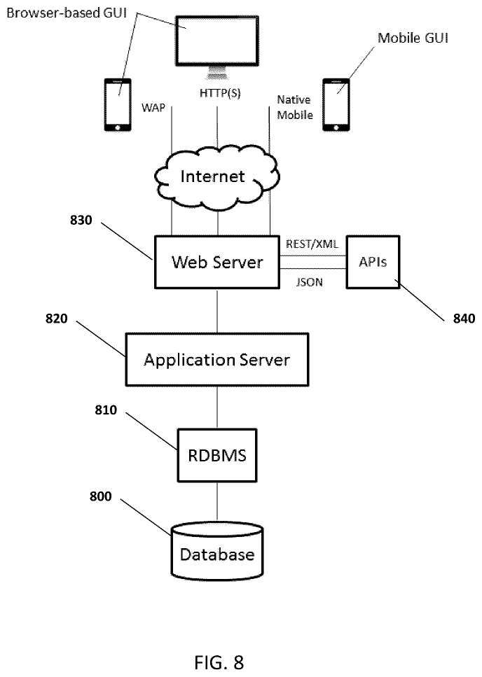

Referring to FIG. 8, application provision system comprises one or more databases 800 accessed by a relational database management system (RDBMS) 810, in accordance with some embodiments. Suitable RDBMSs include Firebird, MySQL, PostgreSQL, SQLite, Oracle Database, Microsoft SQL Server, IBM DB2, IBM Informix, SAP Sybase, Teradata, and the like. In this embodiment, the application provision system further comprises one or more application severs 820 (such as Java servers, .NET servers. PHP servers, and the like) and one or more web servers 830 (such as Apache, IIS, GWS and the like). The web server(s) optionally expose one or more web services via app application programming interfaces (APIs) 840. Via a network, such as the Internet, the system provides browser-based and/or mobile native user interfaces.

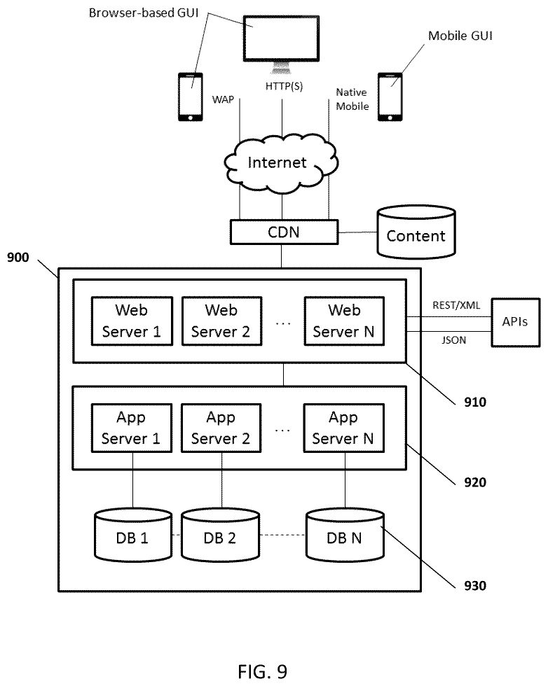

Referring to FIG. 9, an application provision system alternatively has a distributed, cloud-based architecture 900 and comprises elastically load balanced, auto-scaling web server resources 910 and application server resources 920 as well synchronously replicated databases 930, in accordance with some embodiments.

### Mobile Application

In some embodiments, a computer program includes a mobile application provided to a mobile computing device. In some embodiments, the mobile application is provided to a mobile computing device at the time it is manufactured. In other embodiments, the mobile application is provided to a mobile computing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, JavaScript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and PhoneGap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Google® Play, Chrome WebStore, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB.NET, or combinations thereof. Compilation is often performed, at least in part, to create an executable program. In some embodiments, a computer program includes one or more executable complied applications.

### Web Browser Plug-In

In some embodiments, the computer program includes a web browser plug-in (e.g., extension, etc.). In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, those of skill in the art will recognize that several plug-in frameworks are available that enable development of plug-ins in various programming languages, including, by way of non-limiting examples, C++, Delphi, Java™ PHP, Python™, and VB.NET, or combinations thereof.

Web browsers (also called Internet browsers) are software applications, designed for use with network-connected computing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called microbrowsers, mini-browsers, and wireless browsers) are designed for use on mobile computing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM Black Berry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, a distributed computing resource, a cloud computing resource, or combinations thereof. In further various embodiments, a software module comprises a plurality of files, a plurality of sections of code, a plurality of programming objects, a plurality of programming structures, a plurality of distributed computing resources, a plurality of cloud computing resources, or combinations thereof. In various embodiments, the one or more software modules comprise, by way of non-limiting examples, a web application, a mobile application, a standalone application, and a distributed or cloud computing application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on a distributed computing platform such as a cloud computing platform. In some embodiments, software modules are hosted on one or more machines in one location. In other embodiments, software modules are hosted on one or more machines in more than one location.

### Databases

In some embodiments, the systems and methods disclosed herein include one or more databases, or use of the same. In view of the disclosure provided herein, those of skill in the art will recognize that many databases are suitable for storage and retrieval of, for example, users, transactions, and others. In various embodiments, suitable databases include, by way of non-limiting examples, relational databases, non-relational databases, object oriented databases, object databases, entity-relationship model databases, associative databases, XML databases, document oriented databases, and graph databases. Further non-limiting examples include SQL, PostgreSQL, MySQL, Oracle, DB2, Sybase, and MongoDB. In some embodiments, a database is Internet-based. In further embodiments, a database is web-based. In still further embodiments, a database is cloud computing-based. In some embodiments, a database is a distributed database. In other embodiments, a database is based on one or more local computer storage devices.

While preferred embodiments of the present subject matter have been shown and described herein, it will be obvious to those skilled in the art that such embodiments are provided by way of example only. Numerous variations, changes, and substitutions will now occur to those skilled in the art without departing from the present subject matter. It should be understood that various alternatives to the embodiments of the present subject matter described herein can be employed in practicing the present subject matter.

What is claimed is:

1. A computer interfacing system providing a blockchain interface between one or more service provider systems and one or more blockchain ecosystems, the system comprising:
a set of modules interfacing a service provider system, wherein the set of modules comprise an adaptor module integratable with a core processing system of the service provider, and a user interface (UI) module comprising a library of functionalities that are integratable with a UI application of the service provider system, wherein the library of functionalities is related to services provided by the one or more blockchain ecosystems;
a blockchain integration module configured to adapt to the one or more blockchain ecosystems and translate one or more operations specific to a type of a blockchain ecosystem into uniform application programming interface (API) calls; and
an orchestration module in communication with the blockchain integration module via the API calls and configured to facilitate a transaction including a fiat transaction via the one or more blockchain ecosystems or a tokenized digital asset or liability transaction.

2. The system of claim 1, wherein the adaptor module is selected from a library of adaptor modules based at least in part on the core processing system of the service provider.

3. The system of claim 1, wherein the adaptor module provides a plurality of functionalities including API utilization management, failover and auto-recovery, securely managed credentials control, or both.

4. The system of claim 1, wherein the set of modules further comprise a logging and telemetry module that is in communication with a security system of the service provider system.

5. The system of claim 4, wherein the logging and telemetry module comprise technical operation and information security details of the service provider.

6. The system of claim 1, wherein the UI module comprises a secure gateway which is deployable to a public network of the service provider system.

7. The system of claim 1, wherein at least one of the library of functionalities is integrated with the UI application of the service provider system as an integral part of a product provided by the service provider system.

8. The system of claim 1, wherein at least one of the library of functionalities is integrated with the UI application of the service provider system without being displayed to a customer on a product UI.

9. The system of claim 1, wherein the one or more operations comprise mint, burn, signing operations on-chain or operations specific to a product or service provided by a given blockchain ecosystem.

10. The system of claim 1, wherein the orchestration module comprises transactional routing and mediation logic to facilitate the transaction.

11. The system of claim 10, wherein the orchestration module is further configured to update the transactional routing and mediation logic upon receiving a request.

12. The system of claim 11, wherein the orchestration module is configured to select a different adaptor module or a different blockchain ecosystem based on the updated transactional routing and mediation logic.

13. The system of claim 11, wherein the request is indicative of a change of the core processing system, a change of the one or more blockchain ecosystems or a change of a service provided by the one or more blockchain ecosystems.

14. The system of claim 1, wherein the orchestration module comprises an encryption module.

15. The system of claim 14, wherein the encryption module is configured to encrypt a key used to access a currency of the transaction.

16. The system of claim 1, wherein one or more of the set of modules, blockchain integration module and the orchestration module are implemented on a cloud-based platform.

17. The system of claim 1, wherein the service provider is a financial service provider.

18. The system of claim 17, wherein the financial service provider is a bank.

19. The system of claim 1, wherein a blockchain ecosystem of the blockchain ecosystems comprises a distributed ledger.

20. A computer-implemented method for providing a blockchain interface between one or more service provider systems and one or more blockchain ecosystems, the computer-implemented method comprising:
receiving a request indicative of a change in a transaction, wherein the transaction involves a service provider system and a blockchain ecosystem;
based at least in part on the request, determining a set of modules interfacing the service provider system, wherein the set of modules comprise an adaptor module selected from a plurality of adaptor modules based at least in part on a core processing system of the service provider;
determining a blockchain integration module that adapts to the blockchain ecosystem; and
deploying a model comprising the blockchain integration module, the set of modules interfacing the service provider system and an orchestration module to facilitate the transaction.
